(19) United States
(12) Patent Application Publication
(10) Pub. No.: US 2014/0015396 A1
(43) Pub. Date: Jan. 16, 2014

(54) GAS-DISCHARGE LAMP

(71) Applicants: Ulrich Hechtfischer, Aachen (DE); Hermann Giese, Roetgen (DE)

(72) Inventors: Ulrich Hechtfischer, Aachen (DE); Hermann Giese, Roetgen (DE)

(73) Assignee: KONINKLIJKE PHILIPS N.V., EINDHOVEN (NL)

(21) Appl. No.: 14/006,114

(22) PCT Filed: Mar. 15, 2012
(86) PCT No.: PCT/IB2012/051245

§ 371 Date: Sep. 19, 2013

(30) Foreign Application Priority Data
Mar. 24, 2011 (EP) 11159627.6

(51) Int. Cl. H01J 61/33; H01J 9/24

(52) U.S. Cl. CPC H01J 61/33; H01J 9/247
USPC 313/17; 445/26

(57) ABSTRACT

The invention describes a gas-discharge lamp (1) comprising a discharge vessel (11) arranged in an outer quartz glass envelope (12), which gas-discharge lamp (1) comprises a local thermal area contact (2) between a lower surface (21) of a localised deformation (20) of the outer envelope (12) and a corresponding isolated area (22) on the outer surface (23) of the discharge vessel (11). The invention also describes a method of manufacturing a gas-discharge lamp (1), which method comprises the steps of arranging a discharge vessel (11) in an outer quartz glass envelope (12); forming a localised deformation (20) of the outer envelope (12) to create a local thermal area contact (2) between a lower surface (21) of the localised deformation (20) and a corresponding isolated area (22) on the outer surface (23) of the discharge vessel (11).

### FIELD OF THE INVENTION

The invention describes a gas-discharge lamp and a method of manufacturing a gas-discharge lamp.

### BACKGROUND OF THE INVENTION

High-intensity gas-discharge (HID) lamps are used for applications in which a very bright, compact and intense source of light is required. For example, HID lamps are used in automotive front-lighting applications, since they can be used to generate a bright front beam that satisfies the relevant regulations. An HID lamp comprises an outer envelope (or ‘outer bulb’) enclosing a discharge vessel (or ‘inner bulb’) which can be made of glass or ceramic, in which two electrodes are arranged, facing each other across a short gap. During operation, an electric discharge arc is established. The quality of the light produced by the lamp may be governed by the fill gas composition in the discharge vessel. Metal halides are used to improve the luminous efficacy of the lamp and to control the colour point of the light. During operation, plasma temperatures in excess of 5000 Kelvin and wall temperatures above 1000 Kelvin can easily be reached, particularly for small HID lamps with a pressure in the region of several MPa. Owing to convection in the discharge vessel, the wall temperature in the upper part of the discharge vessel is higher than in the lower part. The lamp performance is very much governed by these temperatures, and an overall high temperature is required to maintain a minimum pressure of the metal halides in the lamp.

Excessively high wall temperatures can damage a quartz glass vessel, since the originally amorphous quartz recrystallizes. As a result, the quartz glass becomes opaque. Recrystallization of the quartz glass of a discharge vessel can occur at temperatures in the region of about 1400K, and is usually concentrated in the hottest region of the discharge vessel, e.g. the upper side of the discharge vessel in a horizontally held lamp. Over the lifetime of the lamp, recrystallization damage results in a drop in integral light flux. More importantly, the recrystallization changes the distribution of the light emitted from the lamp and thereby increases the apparent size of the light source so that less light can be collected by surrounding optics in an optical system enclosing the lamp. For an automotive lamp, this effectively means that the headlight casts less light onto the road. Furthermore, the damaged quartz means that the lamp lifetime is shortened.

Insufficient wall temperature, on the other hand, allows the metal salts of the fill gas to condense at the coldest spot in the lamp (generally in the lower part of the discharge vessel), so that these salts are no longer available in the gas phase. As a result, the light output drops.

Therefore, lamp design is made difficult by the conflicting requirements of a minimum wall temperature to ensure a minimum vapour pressure of the metal-halide fill, and a maximum wall temperature to prevent damage to the discharge vessel. However, it is normally very difficult to adjust the top and bottom temperatures independently, e.g., the temperature at the top of the discharge vessel cannot be reduced without also reducing the bottom temperature. This is true in particular for the present-day lamp designs with smaller and more compact design parameters. For example, if an increased light output is desired, this is usually achieved by raising the coldest-spot temperature in the lower part of the discharge vessel. Unfortunately, this generally also increases the quartz temperature in the hottest part of the discharge vessel, resulting in recrystallization and, ultimately, a corresponding deterioration in the lumen maintenance of the lamp.

Some attempts at circumventing these problems are based on the principle that heat can be transferred from the discharge vessel to the outer bulb, where it can be dissipated. The outer bulb is usually dimensioned so that it is separate from the inner bulb by a small, uniform distance, for example a gap of at most a few millimetres measured at the widest point of the discharge vessel. In general, the efficiency of the heat transfer between the discharge vessel and the outer bulb depends on the gap between the inner and outer bulbs. The thermal conductance of this gap, given by the width of the gap and the thermal conductivity of any gas fill between the outer bulb and the inner bulb (referred to as the ‘outer bulb fill gas’), is normally much lower than the thermal conductance of the adjacent bulk material of the inner bulb and the outer bulb. In principle, heat transfer from the inner bulb to the outer bulb can be effected by using an outer-bulb fill gas with high thermal conductivity, e.g. neon. However, such heat transfer will take place over the entire circumference of the lamp, so that the temperature of the discharge vessel as a whole will be lowered. This has a negative effect on the metal-halide pressure. One way of attempting to restrict the heat transfer to a specific region, for example a region over the hottest part of the discharge vessel, might be to arrange the (normally spherical or ellipsoidal) discharge vessel very close to or even in contact with the outer bulb. However, the smaller gap achieved in this manner is restricted to a geometric point or line, and the resulting local heat transfer will not be very effective. Furthermore, such lamp designs are complicated to realise, and therefore also more expensive, since additional steps must be taken in the manufacturing process to achieve an off-centre position of the discharge vessel in the outer bulb.

Therefore, it is an object of the invention to provide an improved gas-discharge lamp that avoids the problems described above.

### SUMMARY OF THE INVENTION

This object is achieved by the gas-discharge lamp according to claim 1, and by the method according to claim 11 of manufacturing a gas-discharge lamp.

According to the invention, the gas-discharge lamp comprises a discharge vessel arranged in an outer quartz glass envelope, and the gas-discharge lamp comprises a local thermal area contact between a lower surface of a localised deformation of the outer envelope and a corresponding isolated area on the outer surface of the discharge vessel.

The term “local thermal area contact” is to be understood as a local thermal contact over an essentially planar area, as opposed to a local thermal point contact or local thermal line contact, whereby the thermal contact serves to transfer heat from one body to another, in this case from the discharge vessel to the outer envelope. The term “lower surface” is to be understood to mean the underside of the localised deformation, namely that surface which is applied to or makes contact with the outer surface of the discharge vessel. The term “isolated area” is to be understood to mean a relatively small island-like region with a well-defined single boundary or perimeter, over which the gap between the discharge vessel and the outer bulb is significantly smaller than over the remainder of the discharge vessel. The local thermal area contact therefore only affects a confined or insular region of the outer surface of the discharge vessel, and it should be clear that the thermal area contact does not extend around the discharge vessel. The localised deformation of the outer envelope, in order to make a local thermal area contact with the outer surface of the discharge vessel, extends into the outer envelope towards the discharge vessel.

An advantage of the invention is that the gap between the isolated area and the underside of the localised deformation extends over a significant planar area, as opposed to only a point or line, and the efficiency of heat transfer over this area contact is greatly increased compared to the known point or line contacts described above.

An advantage of the lamp according to the invention is that the thermal load on the upper wall of the in the discharge vessel can effectively be transferred to the outer bulb and eventually to the exterior of the lamp via the local thermal area contact. This allows more freedom in adjusting the lamp parameters. For example, if an increased light output is desired over the usual lifetime of the lamp, this can be achieved with the lamp according to the invention, since the higher temperatures at the top side are mitigated by the heat transfer over the local thermal area contact, the lumen maintenance of the lamp remains favourably high over the normal lifetime of the lamp. Alternatively, the local thermal area contact can act to prevent the temperature in the discharge vessel from reaching a level at which recrystallization would occur, such as to improve the lumen maintenance and the lifetime of lamps with normal light output.

According to the invention, the method of manufacturing a gas-discharge lamp comprises the steps of arranging a discharge vessel in an outer quartz glass envelope and forming a localised deformation of the outer envelope to create a local thermal area contact between a lower surface of the localised deformation and a corresponding isolated area on the outer surface of the discharge vessel.

An advantage of the method according to the invention is its simplicity. There is no need to alter the initial design of the discharge vessel or the outer envelope. Instead, these can be manufactured in the usual manner. The step of forming the localised deformation of the outer envelope can be carried out after the lamp has been assembled in the established manufacturing process.

The dependent claims and the subsequent description disclose particularly advantageous embodiments and features of the invention. Further embodiments may be derived by combining the features of the various embodiments described below. Features described in the context of one claim category can apply equally to another claim category.

In the following, without restricting the invention in any way, the gas-discharge lamp or “burner” is assumed to have a quartz glass discharge vessel and a quartz glass outer bulb, with a pair of electrodes arranged along a longitudinal axis to face each other across a short gap. Furthermore, it is assumed that the lamp is generally held in a horizontal position during operation, so that the discharge arc is horizontal, with the highest part of the arc and therefore also the hottest region towards the top of the discharge vessel, and the coolest temperatures towards the bottom of the discharge vessel. Without restricting the invention in any way, it is assumed in the following that the lamp is a metal-halide mercury-free xenon HID lamp, for example a D4 lamp for automotive purposes.

As mentioned above, the plasma in the discharge vessel reaches very high temperatures during operation, and the forces of convection result in the development of a hotter plasma region above the discharge arc and a relatively cooler plasma region below the discharge arc. The hot plasma heats the enclosing discharge vessel, and the upper region of the discharge vessel is correspondingly hotter than the lower region. This hottest region or ‘hot spot’ is therefore the region that is most susceptible to recrystallization damage. Therefore, in a particularly preferred embodiment of the invention, the isolated area of the outer envelope is an area of the discharge vessel that is hottest during operation of the gas-discharge lamp. For a horizontally held lamp in which the discharge arc is established essentially in the centre of the discharge vessel, viewed from above, the isolated area is preferably essentially in the middle of an upper surface of the discharge vessel.

The localised deformation can have any suitable shape. For example, the localised deformation could be formed as a type of cleft along the outer envelope. However, particularly for an automotive application, the images of the light source that are used to form the front beam are preferably not subject to any discernible deformation. Therefore, in a further preferred embodiment of the invention, the localised deformation of the outer envelope comprises a localised indentation of the outer envelope extending into the interior of the outer envelope. In this way, a local thermal area contact can be made between the hottest region of the discharge vessel (above the plasma) with a minimum of optical distortion. For the example of a horizontally held lamp, therefore, the localised indentation or ‘dent’ is preferably formed into the upper side of the outer envelope. Experiments with such lamps having a localised indentation of the outer envelope extending into the upper surface of the outer envelope showed only a very minor deformation in the corresponding light source images, and this deformation did not detract from the quality of the front beam.

The local thermal area contact is made by a surface contact between two objects, in this case the discharge vessel and the outer envelope. The local thermal area contact could be formed by an adhesive bond over the isolated area on the discharge vessel. Alternatively, if the discharge vessel and the outer envelope are both made of the same material, e.g. quartz glass, the local thermal area contact could be formed by heat-fusing the glass of both bodies over the isolated area. However, experiments have shown that a very effective heat transfer can be obtained by a close physical surface contact between the underside of the localised deformation and the isolated area, without any bonding or fusing, for example when the outer bulb is filled with a gas that acts to efficiently transfer heat over the gap. Since the bodies make contact but are still separate entities, they are separated by a ‘gap’, however microscopic, and the closeness of the thermal area contact can be expressed as a distance, however small. Since such a separation is essentially negligible, it will be referred to in the following as a ‘micro-separation’. In a particularly preferred embodiment of the invention, the local thermal area contact comprises a micro-separation of at most 20 μm, more preferably at most 10 μm, most preferably at most 1.0 μm between the lower surface of the localised deformation and the isolated area on the outer surface of the discharge vessel. When these surfaces are separated by such a micro-separation, a surface contact is effectively established, since heat can be transferred from the discharge vessel to the outer envelope almost as effectively as if these surfaces were bonded or fused. In the following, it is to be understood that the local thermal area contact is formed over a region in which the lower surface of the localised deformation is separated from the isolated area on the discharge vessel by a micro-separation of at most 20 μm (which can also be expressed as 20×10⁻⁶ m or 20 micrometers).

To effectively transfer as much heat as possible from the discharge vessel to the outer envelope and then to the exterior of the lamp, a relatively large local thermal area contact is favourable. Because the outer envelope and the discharge vessel are essentially curved bodies, the lower surface of the localised deformation can also comprise a curved plane, whereby this curved plane can at least partially follow the curvature of the discharge vessel. Therefore, in a preferred embodiment of the invention, the lower surface of the localised deformation comprises an essentially planar surface. The manner in which such a planar surface can be formed will be explained below.

The area contact could comprise several smaller contact areas, for example two adjacent contact areas, formed by two adjacent localised deformations that collectively act to transfer heat from the discharge vessel to the outer envelope. Preferably, however, a single localised deformation is formed to give a single contact area.

To allow an efficient heat transfer, the lower surface of the localised deformation should be dimensioned so that thermal energy can be effectively transferred from the wall of the discharge chamber to the wall of the outer envelope. As indicated above, the efficiency of the heat transfer is also dependent to a large extent on the size of the ‘gap’ between the surfaces of the local indentation and the isolated area. In developing the lamp according to the invention, it was possible to reliably obtain a very close separation in the region of only a few tens of micrometers between the isolated area and the indentation, and it was observed that heat was very effectively transferred from the isolated area to the indentation. For such a negligible gap, therefore, the lower surface of the localised deformation and therefore the local thermal area contact preferably comprises an area of at least 0.5 mm².

The lower surface of the localised deformation i.e. the shape of the local thermal area contact and therefore also the shape of the isolated area can have any suitable shape. However, the ‘hot spot’ on the discharge vessel, corresponding to a region above the discharge arc, may be essentially round. Therefore, in a preferred embodiment of the invention, the lower surface of the localised deformation comprises an essentially circular shape. With such a shape, the contour of the local thermal area contact can cover a large proportion or even all of the ‘hot spot’, so that a favourably efficient heat transfer is obtained. Preferably, the lower surface of the localised deformation comprises a contact radius of at least 0.5 mm. Here, the term “contact radius” is to be understood as the average radius of the underside or lower surface of the localised deformation that makes contact with the discharge vessel.

The localised deformation can be formed in a very simple manner. For example, the outer envelope can be heated to soften at least the area in which the localised deformation is to be formed. A suitably shaped tool, for example a narrow blunt rod, could be used to push the soft glass inwards, forming a depression that makes contact with the surface of the discharge vessel. However, since the localised deformation acts to compress any gas in the space between the outer envelope and the discharge vessel, the pressure in this space might act to raise or lift the under surface of the localised deformation away from the isolated area again, thus increasing the micro-separation and decreasing the effectiveness of the local thermal area contact. Therefore, in a particularly preferred embodiment of the invention, the method of manufacturing the lamp comprises the step of filling the outer quartz glass envelope with an outer gas fill at a pressure below atmospheric pressure. Therefore, any indentation made in the outer envelope will not be forced back out again.

The local thermal area contact could comprise a fused quartz bond between the lower surface of the local deformation and the isolated area on the outer surface of the discharge vessel. To make such a bond, a laser could be used to locally heat the under surface of a localised deformation and/or the isolated area of the discharge vessel. However, such a technique might be cost-intensive or time-consuming. Therefore, in a preferred embodiment of the invention, the step of forming a localised deformation of the outer envelope comprises simply heating a portion of the outer envelope until the heated portion is softened, whereby the heated portion is located above a region of the discharge vessel that corresponds to the ‘hot spot’. When that region of the quartz glass of the outer bulb is softened, the softened part is drawn or sucked in towards the isolated area on the discharge vessel by the negative pressure of the gas in the space between the outer envelope and the discharge vessel. In this approach, the discharge vessel remains relatively cool so that no bonding as such occurs, but the force of the negative pressure is sufficient to ensure a very close contact with the desired very small micro-separation of at most 20 micrometers.

The relevant geometrical properties of the local thermal area contact, namely the contact radius and the width of the gap, can be studied by high-resolution x-ray absorption imaging. If the lamp according to the invention is imaged laterally, and several images are taken for different angles of rotation around the lamp axis, the shape of the local thermal area contact can be clearly observed. The width of the gap can be estimated using this method, but a more precise assessment of the gap and of the nature of the contact (fused, bonded, finite gap) is possible using optical methods, for example by reflecting diagnostic laser beams off the lower surface of the localised deformation and off the isolated area and analysing reflection intensities and angles to deduce the gap area.

The effectiveness of the local thermal area contact can be directly measured at the surface of the outer envelope, since heat is transferred from the discharge vessel in the interior to that outer surface and raises the local temperature there. For example, in the case of a lamp operating horizontally the temperature can be measured pyrometrically along a longitudinal axis along the upper surface of the outer envelope, running the length of the outer envelope. For a conventional lamp, the temperature along that axis will reach a maximum at a point corresponding to the centre of the lamp, and decrease steadily towards the outer ends. For a D4 HID lamp, for example, temperatures of about 900K have been observed at the centre, decreasing to about 700K at 10 min distance from the centre. For the same lamp, modified to have a local thermal area contact according to the invention, the temperature at the centre, i.e. in the centre of the localised deformation, is considerably higher, indicating that heat is effectively being transferred form the discharge vessel to the outer envelope. This observed temperature increase in the centre of the localised deformation is directly related to the contact radius and the micro-separation of the area contact. Preferably, the local thermal area contact is realised such that a temperature in a central region of the local deformation is at least 60K, more preferably at least 70K, most preferably at least 80K higher than the temperature that would be measured at the same position on an identical lamp without such a localised deformation. For a D4 lamp according to the invention, temperatures close to 1000K have been measured in the centre of the dent or localised deformation, showing that the heat transfer from the discharge vessel to the outer envelope (via the dent) is most effective. The effectiveness of the local thermal area contact can also be expressed in other terms, for example in terms of its heat transfer coefficient, its thermal conductance, its thermal resistance, etc. Preferably, the local thermal area contact is dimensioned to obtain a thermal conductance of at least 5 milliwatt per Kelvin (mW/K), corresponding to a thermal resistance of at most 200 Kelvin per Watt.

### BRIEF DESCRIPTION OF THE DRAWINGS

FIG. 1 shows a prior art gas-discharge lamp with a recrystallized region;

FIG. 2 shows a gas-discharge lamp with a local thermal area contact according to an embodiment of the invention;

FIG. 3 shows a simplified rendering of the outer envelope of the lamp of FIG. 2;

FIG. 4 shows a simplified rendering of the discharge vessel of the lamp of FIG. 2;

FIG. 5 shows a simplified axial cross-section of the local thermal area contact of FIG. 2;

FIG. 6 shows graphs of the calculated temperature at the upper inner wall for a reference lamp and a number of lamps according to the invention;

FIG. 7 shows graphs of outer-bulb temperature distributions for a reference lamp and a lamp according to the invention;

FIG. 8 shows graphs of integral lumen maintenance for a lamp according to the invention and a reference lamp.

In the drawings, like numbers refer to like objects throughout. Objects in the diagrams, particularly objects or dimensions relating to the local thermal area contact, are not necessarily drawn to scale.

### DETAILED DESCRIPTION OF THE EMBODIMENTS

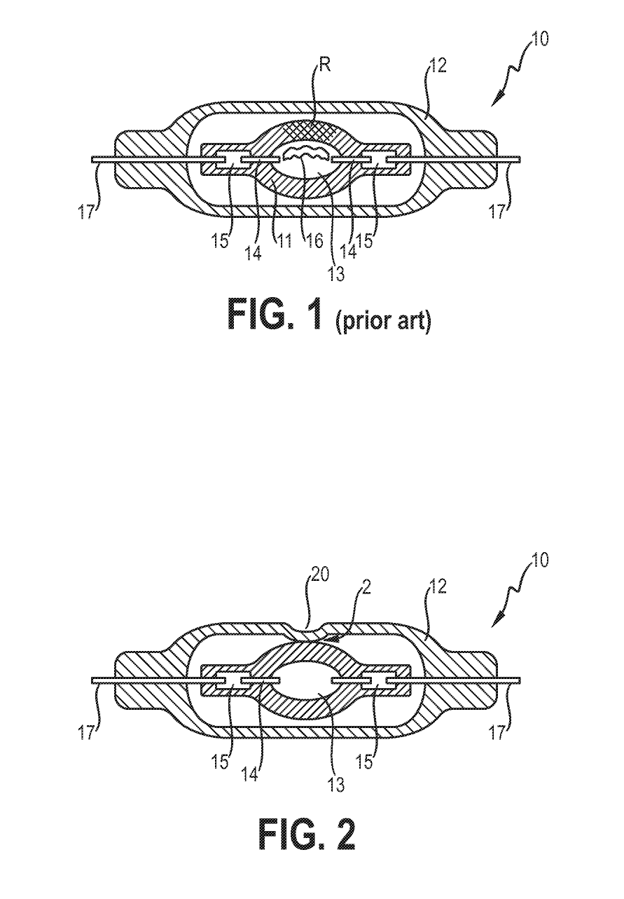

FIG. 1 shows a prior art gas-discharge lamp 10 with a discharge vessel 11 arranged in an outer envelope 12. A pair of electrodes 14 protrudes into the discharge vessel 11. To mitigate thermo-mechanical stress owing to the high temperatures obtained during operation, an electrode 14 is usually connected to an exterior lead 17 by a flat molybdenum foil 15 enclosed in a pinch end of the discharge vessel 11. During operation, a discharge arc 16 is established between the electrode tips. Due to convection and the plasma nature of the discharge arc, the temperature in the upper region of the discharge vessel 11 is higher than in the lower region of the discharge vessel 11. For the reasons mentioned in the introduction, a high wall temperature in the lower vessel region is desired, since this ensures that sufficient metal salts are available in the plasma so that a high light output can be achieved. Because the wall temperature in the upper region is always higher than in the lower region, this means that the very high temperatures reached in the upper region ultimately result in a visible recrystallization in that region. The “whitened” quartz glass results in an overall loss of light, a loss of light collectable in the application, and a shorter lamp lifetime. Such a whitened area is indicated by the cross-hatched region R in the diagram.

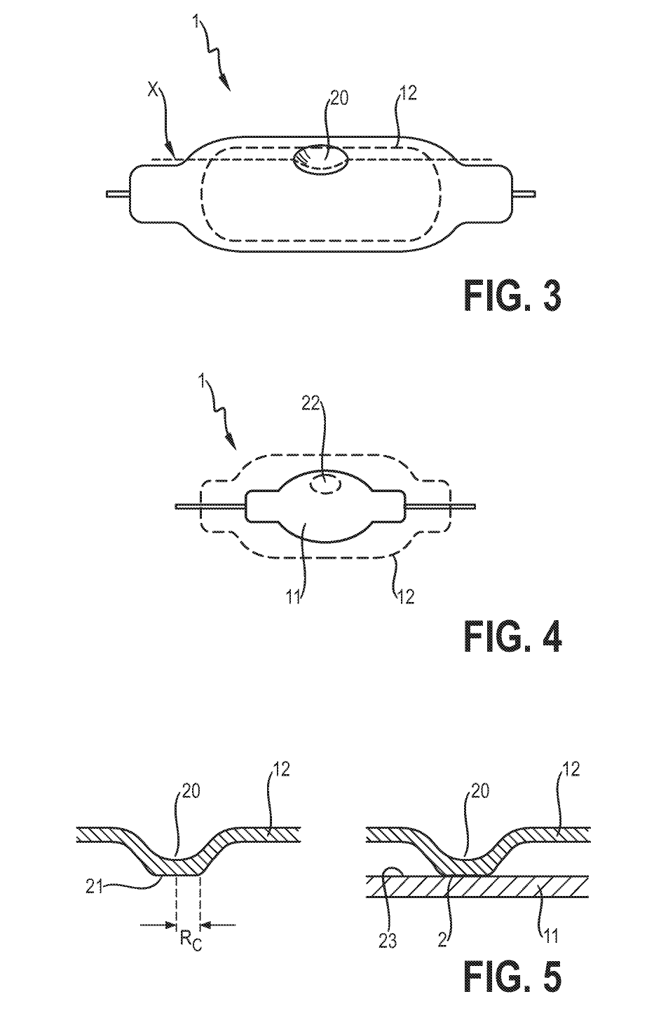

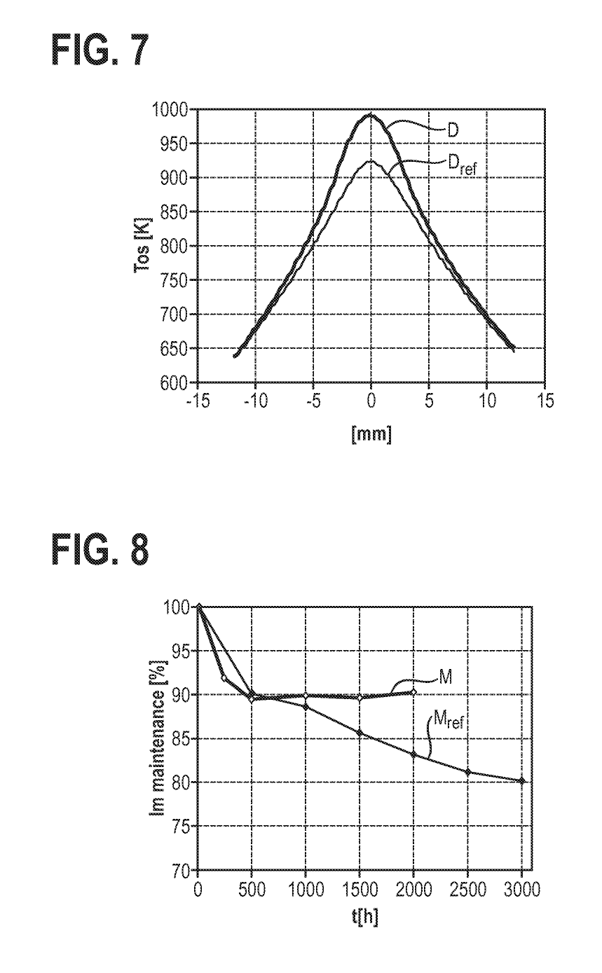

FIG. 2 shows a gas-discharge lamp 1 according to an embodiment of the invention. The construction of this lamp 1 is essentially the same as for the lamp 10 of FIG. 1. However, the lamp 1 according to the invention has a local thermal area contact 2, made by a deformation of the outer envelope 12 so that a physical contact is made, over a small area, between the inside surface of the outer vessel 12 and the outer surface of the discharge vessel 11. FIG. 3 is a simplified rendering of the outer envelope 12 of the lamp of FIG. 2, showing a “dent” 20 in the outer envelope 12, which dent 20 extends into the interior of the outer envelope 12. The local thermal area contact 2 ensures that heat can be very effectively transferred from the discharge vessel 11 to a region on the outer bulb 12 of the lamp 1, where it is dissipated. The effectiveness of the heat transfer can be shown by measuring the temperature along a virtual axis X extending along the outer surface of the outer vessel 11 and bisecting the dent 20. This will be illustrated later with the aid of FIG. 7.

FIG. 4 shows a simplified rendering of the discharge vessel 11 of the lamp of FIG. 2. The outer envelope 12 is only indicated schematically by means of the broken line. FIG. 4 shows the relatively small isolated area 22 that is contacted by the localised deformation 20 of the outer envelope 12. In this diagram, the isolated area 22 is essentially round, in keeping with the essentially circular dent shown in FIG. 3. FIG. 5 shows a simplified enlarged cross-section of the dent of FIG. 3 (on the left-hand side of the diagram) which makes a local thermal area contact 2 when the lower surface 21 of the dent 20 meets or makes surface contact (on the right-hand side of the diagram) with the isolated area 22 of FIG. 4. The local thermal area contact 2 effectively comprises the shared surface regions of the dent underside 21 and the isolated area 22. The isolated area 22 comprises only a small fraction of the outer surface 23 of the discharge vessel 11. The “size” of the local thermal area contact 2 can be expressed in terms of a contact radius R_{C}, since an essentially circular dent 20 will make contact with an essentially circular isolated area 22 on the discharge vessel 11. Although the body of the discharge vessel 11 itself is essentially cylindrical or elliptical with a correspondingly curved outer surface 23, the local thermal area contact 2 over the isolated area 22 is so small that the shape of the isolated area 22 may be regarded as essentially circular also.

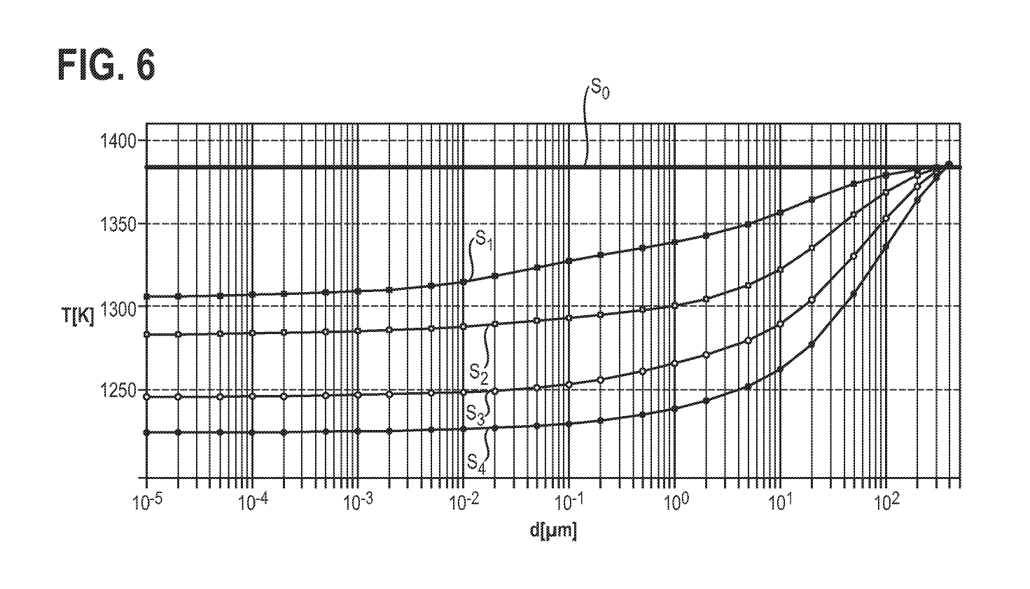

Plasma temperatures in the discharge vessel can easily reach levels of several thousand Kelvin. FIG. 6 shows graphs of the calculated upper inner-wall temperature (in Kelvin), the hottest part of the discharge vessel where the risk of recrystallization is highest, for various realizations of thermal area contacts for a lamp according to the invention and for a prior art lamp. The temperature for the reference lamp is given by the horizontal line S₀, since a reference lamp does not have any local thermal area contact between its outer envelope and its discharge vessel. According to the calculations, which are based on reliable finite-element thermal models, the upper inner-wall temperature for such a lamp is about 1400 K. In the lamp according to the invention, the local thermal area contact acts to transport heat from the discharge vessel to the outer envelope, where it can dissipate. The effectiveness of a thermal area contact is directly related to the contact radius of the underside of the dent, and the closeness of the gap of thermal area contact. In the following, the expression “local thermal area contact with contact radius of x mm over a micro-separation of y μm” is to be understood to mean a local thermal area contact for which the lower surface of the localised deformation has a radius of x mm and the gap between the lower surface of the localised deformation and the discharge vessel is on average y μm. A first curve S₁ shows the upper inner-wall temperature for a local thermal area contact with a contact radius of 0.5 mm. As the graph indicates, a maximum upper inner-wall temperature of about 1340K can be achieved at a separation of 1.0 μm (10⁰ μm). As the surface contact between dent underside and isolated area becomes tighter (the surfaces are ‘pressed’ closer together), the temperature is reduced further, so that a favourable temperature of only about 1310K is achieved for a negligible separation of about 10⁻³ μm or 0.001 μm. Curves S₂, S₃ show plots of calculated upper inner-wall temperature for local thermal area contacts with contact radius of 1.0 mm and 1.5 mm respectively. For the local thermal area contact with a contact radius of 1.0 mm (graph S₂), the upper inner-wall temperature can be reduced to about 1300K for a micro-separation of 1.0 μm. For the local thermal area contact with contact radius of 1.5 mm (graph S₃), the upper inner-wall temperature can be reduced to about 1265K for the same micro-separation. For an automotive lamp, a local thermal area contact with contact radius in the region 1.0 mm-1.5 mm provides a very favourable heat transport to the outer envelope, while the relatively small contact radius implies a minimal or even negligible optical distortion, so that the quality of the beam pattern generated with such a lamp is comparable to that of a reference lamp. In contrast to the reference lamp, however, the lamp according to the invention can exhibit a longer lifetime and improved lumen maintenance, as indicated already. A fourth curve S₄ shows the temperature for a local thermal area contact with a contact radius of 2.0 mm. Here, a reduced upper inner-wall temperature of only about 1225K can be achieved for a micro-separation of 1.0 μm. However, such a lamp, while having a very favourable heat transport, may exhibit an unfavourable degree of optical distortion on account of the relatively large contact radius of the dent in the outer envelope.

FIG. 7 shows graphs of outer-bulb temperature distribution for a D4 lamp according to the invention and a reference D4 lamp. The lamps are identical except for the local thermal area contact of the inventive lamp. The external temperature T_{OS} is measured in Kelvin for each lamp along a virtual line along the top outside surface of the outer envelope, as described in FIG. 3 above. The graph D_{ref} shows a steadily increasing temperature from the outer regions of the outer envelope towards the centre, whereby the “centre” is a point above the discharge arc. At about 10 mm on either side of the centre, the temperature on the outside of the outer envelope is about 700K. Moving closer to the centre, the temperature rises steadily, reaching about 925K at the centre. The graph D shows the external temperature distribution for a D4 lamp according to the invention with a local thermal area contact with a contact radius of about 0.5 mm and a micro-separation of at most 10 μm over the local thermal contact area, wherein the temperature is measured in the same way as for the reference lamp. Referring again to FIG. 3, the “centre” in this case coincides with the middle of the dent. This graph D also shows a temperature of about 700K at about 10 mm on either side of the centre. This temperature can be regarded as a reference temperature, since it is the same for both conventional and inventive lamps. However, owing to the effective heat transfer over the local thermal area contact, the outer vessel in the region of the dent is heated by the very hot discharge vessel, so that the temperature at the centre of the virtual line, i.e. the centre of the dent, reaches a maximum of about 990K. Referring to the graph of FIG. 6, the temperature at the hottest part of the discharge vessel for a local thermal contact area with a micro-separation of about 10 μm comprises only about 1320 K. At this lower temperature, recrystallization of the quartz glass of the discharge vessel is strongly reduced, so that the lamp lifetime is prolonged, and the light output of the lamp can be maintained at a favourably high level over the lamp lifetime. Alternatively, with the favourable heat transfer made possible by the local thermal area contact, the lamp could be driven at higher temperatures to provide a higher light output over a lifetime comparable to that of a conventional lamp, which would be damaged by those high temperatures.

FIG. 8 shows graphs of lumen maintenance (in percent) for a lamp according to the invention and a reference lamp. For both lamps, the lamp dimensions, electrode dimensions and fill gas composition were the same, and the only difference lay in the local thermal area contact of the lamp according to the invention. For a gas-discharge lamp of the type discussed herein, the highest light output, or 100% light output, is generally achieved by the new lamp (conventionally defined after an initial burning-in phase of 15 hours). Thereafter, a drop in light output to about 90% of the initial light output is observed, which is largely due to chemical changes of the metal-halide fill. Ultimately, the temperature in the discharge vessel of the reference lamp causes recrystallization to occur, so that the lumen output drops further over the lamp's lifetime. For the reference lamp used in these measurements, the lumen maintenance dropped to about 80% after 3000 hours of operation. In contrast, the lamp according to the invention was able to maintain its light output over the same time span, as shown by the graph M. This graph M also shows the initial drop in lumen maintenance characteristic of this lamp type, but once the lumen maintenance has dropped to the 90% level, it was observed to remain close to this level for at least 2000 hours of operation. This favourable performance is due to the effective heat transfer via the local thermal area contact, which effectively prevents the top of the discharge vessel from heating too much and thus essentially avoiding recrystallization and subsequent “whitening”, so that the transparency or transmissivity of the quartz glass discharge vessel is not adversely affected.

Although the present invention has been disclosed in the form of preferred embodiments and variations thereon, it will be understood that numerous additional modifications and variations could be made thereto without departing from the scope of the invention.

For the sake of clarity, it is to be understood that the use of “a” or “an” throughout this application does not exclude a plurality, and “comprising” does not exclude other steps or elements. A reference to a “unit” or “module” does not exclude a plurality of units or modules.

1. A gas-discharge lamp comprising a discharge vessel arranged in an outer quartz glass envelope, which gas-discharge lamp comprises a local thermal area contact between a lower surface of the outer envelope and a corresponding isolated area on the outer surface of the discharge vessel,
wherein the local thermal contact is a localized deformation of the outer envelope comprising an indentation, which indentation extends into the interior of the outer envelope.

2. A lamp according to claim 1, wherein the isolated area comprises an area of the discharge vessel that, due to the mounting orientation of the lamp, is hottest during operation of the gas-discharge lamp.

3. (canceled)

4. A lamp according to claim 1, wherein the lower surface of the localised deformation comprises an essentially planar surface.

5. A lamp according to claim 1, wherein the lower surface of the localised deformation comprises an area of at least 0.5 mm².

6. A lamp according to claim 1, wherein the lower surface of the localised deformation comprises an essentially circular shape.

7. A lamp according to claim 6, wherein the lower surface of the localised deformation comprises a contact radius of at least 0.5 mm.

8. A lamp according to claim 1, wherein the local thermal area contact comprises a separation of at most 20 μm, more preferably at most 10 μm, most preferably at most 1.0 μm between the lower surface of the localised deformation and the isolated area on the outer surface of the discharge vessel.

9. A lamp according to claim 1, wherein the local thermal area contact exhibits a thermal resistance of less than 200 Kelvin per Watt.

10. A lamp according to claim 1, wherein the gas-discharge lamp is a metal halide high-intensity gas-discharge lamp with a quartz glass outer envelope and a quartz glass discharge vessel.

11. A method of manufacturing a gas-discharge lamp, which method comprises the steps of
arranging a discharge vessel in an outer quartz glass envelope;
forming a localised deformation of the outer envelope to create a local thermal area contact between a lower surface of the localised deformation and a corresponding isolated area on the outer surface of the discharge vessel.

12. A method according to claim 11, comprising the step of filling the outer quartz glass envelope with an outer gas fill at a pressure below atmospheric pressure.

13. A method according to claim 12, wherein the step of forming a localised deformation of the outer envelope comprises applying heat to a portion of the outer quartz glass envelope until the heated portion is softened.

14. A method according to claim 11, wherein the softened heated portion is deformed to press against the isolated area of the outer surface of the discharge vessel.

15. (canceled)
